(19) United States
(12) Patent Application Publication
(10) Pub. No.: US 2003/0044030 A1
(43) Pub. Date: Mar. 6, 2003

(54) Control device for mixing and positioning

(76) Inventor: Bing-Ren Ching, Hsintien-City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/940,703

(22) Filed: Aug. 29, 2001

(51) Int. Cl. H04B 1/00; H04N 5/60

(52) U.S. Cl. 381/119

(57) ABSTRACT

A control device for mixing and positioning voices comprises at least one input audio channel controllers, at least one output audio channel controllers, and at least one preset changing main controller. Each input audio channel controller further comprises an input electric balance controller, an input to output connection controller; and a main controlling loop selector. Each preset changing main controller further comprises a change control button and a change selector. The voice output is set according to visual viewpoint and movement viewpoint. When a viewpoint of an image changes or movements, the viewpoint and position of the position are also changed. The setting of voice positioning must be designed to match the visual viewpoint.

### FIELD OF THE INVENTION

The present invention relates to a control device for mixing and positioning voices, in for example the audio mixing of movie and TV5.1. Moreover, the multi-audio channel outputs can be performed. Furthermore, the multi-audio channel outputs can be performed for stage performance and other special formats.

### BACKGROUND OF THE INVENTION

In general, for dramas of TV or movies, the voices are recorded behind the scenes for presenting a stereo effect or a sound effect. But for the live show or stage show, in general, the voices recorded behind the scenes can not be well matched to the image. The recorded voices can not be present as that in the live show even many microphones are used. The primary factor for this problem is due to mixing of audio. In general, the mixing of audio is performed manually, and thus at one time, only two microphones are controlled in this method since one hand only controls a button. Moreover, the control is performed gradually.

For a live show, the voice is manually controlled to match the viewpoint of lens of the camera according to the indication of the director. If the lens points to a music instrument, then the voice of said instrument is amplified. However, if the lens moves rapidly, it is often that the voice can not well match the viewpoint of the lens.

Although current mixing positioning and control ways and the devices of the same are equipped with multi-switches or potential meters, it is confined to a single audio channel, double audio channels, or multi-double audio channels. For example, for five audio channels, only right or left audio channel, or middle audio channel, or left surrounding sound effect or right surrounding effect is controlled. It is impossible that the five audio channels outputs voices at the same time. A balance control is used to control the mixing of the left and right sides. Moreover, a joystick is used in the mixing controller, but for synchronous multiple audio channel control, the mixing becomes very complex. It is possible to define a certain mixing way single, while it is impossible to define a synchronous variation of multi-input and multi-outputs. Currently, computers are used to the mixing control, but the control way is indirect. In general, it is suitable in the control of behind the scenes since at a time, only one action is operated through a computer mouse. Therefore, it is not suitable to be used in a live show.

### SUMMARY OF THE INVENTION

Accordingly, the primary object of the present invention is to provide a control device for mixing and positioning voices, wherein the audio mixing of movie and TV5.1. Moreover, the multi-audio channel outputs can be performed. Furthermore, the multi-audio channel outputs can be performed for stage performance and other special formats.

Another object of the present invention is to provide a control device for mixing and positioning voices, wherein the positioning of the stereo is matched to the viewpoint of a camera so that the video and audio effect are synchronous.

Another object of the present invention is to provide a control device for mixing and positioning voices, wherein the various audio signals are mixed and then outputs.

Another object of the present invention is to provide a control device for mixing and positioning voices, wherein voice control is designed to match the movement of an object, the voices of a variety of independent movements are inputted to the audio channels.

Another object of the present invention is to provide a control device for mixing and positioning voices, wherein the main controlling loop selector has a plurality of audio mixing positioning controller for setting the control voice input based on the visual viewpoint or moving objects.

The various objects and advantages of the present invention will be more readily understood from the following detailed description when read in conjunction with the appended drawing.

### BRIEF DESCRIPTION OF THE DRAWINGS

FIG. 1 and 2 are structural schematic views for the control device for mixing and positioning voices in the present invention.

FIG. 3 is a structural schematic view showing the combination of the input audio and output audio of the preset changing main controller in the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

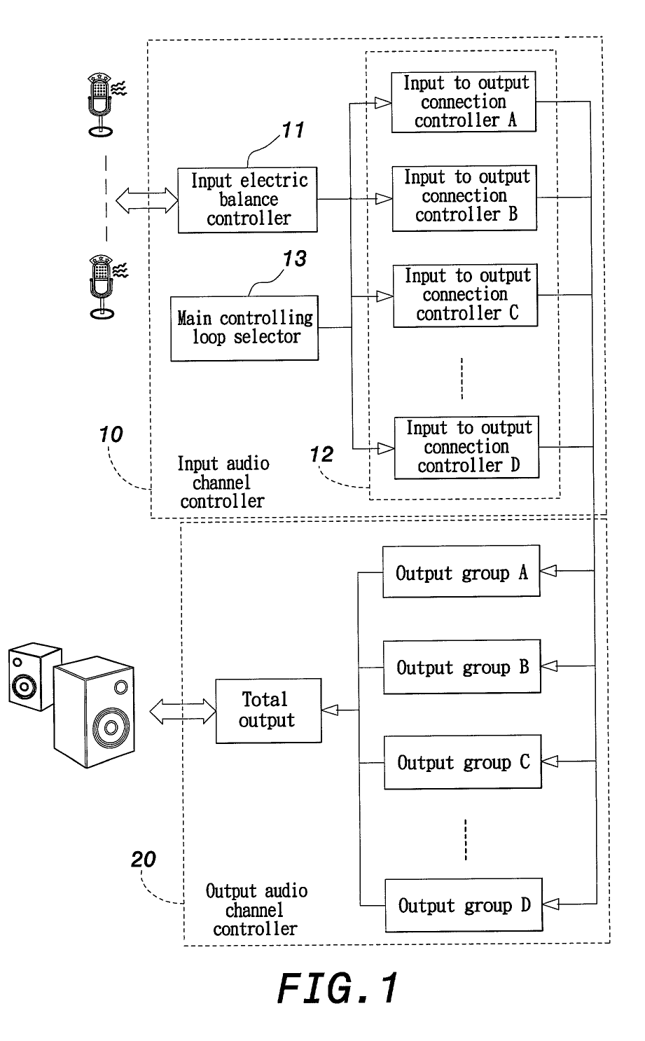

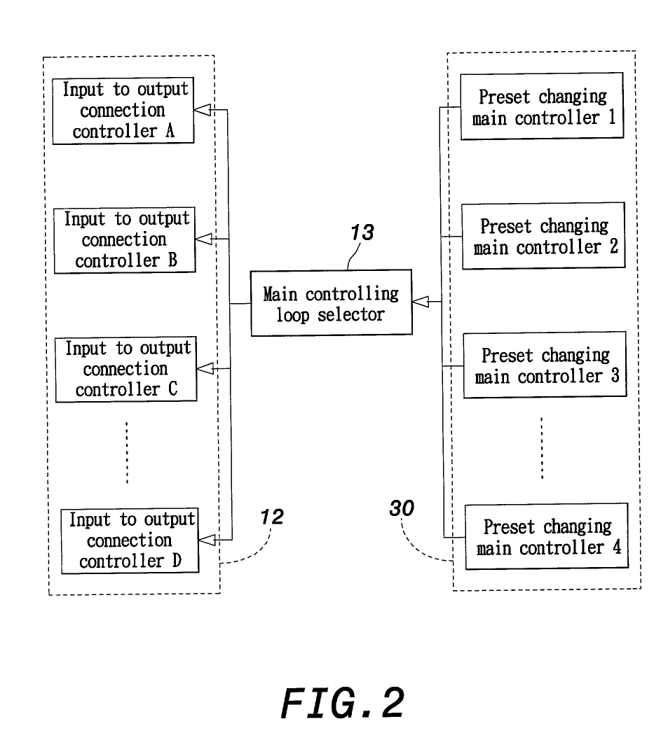

Referring to FIGS. 1 and 2, a schematic view about the method for audio mixing and positioning and a system structure of the device of the same according to the present invention is illustrated. The structure of the present invention includes an input audio channel controller 10, an output audio channel controller 20, and a preset changing main controller 30. The input audio channel controller 10 has an input electric balance controller 11 for controlling the amplitude of the audio input to be at the level of the general mixing controller; an input to output connection controller 12 for setting the combination from the input channel to the output channel; Each input is correspondent to at least one output channel; a main controlling loop selector 13 for selecting a certain input to output connection controller 12 to be controlled by a preset changing main controller 30, and for setting a separation operation, i.e., setting a certain input to output connection controller 12 to operate independently without being controlled by the main controlling loop selector 13.

The output audio channel controller 20 controls the combination of the output channel based on the combination of the input channel to the output channel set by the input to output connection controller 12. In each set, the number of the output loop is correspondent to the number of the combination set by the input to output connection controller 12. Furthermore, the output audio channel controller 20 directly outputs of the signals from the output channel of each set, or the signal is mixed twice and then is outputted.

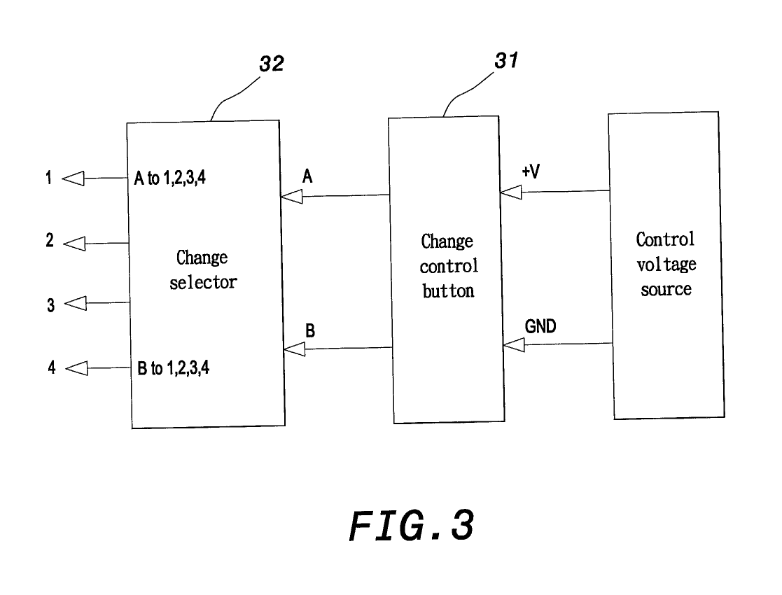

Referring to FIG. 3, a structural schematic view of the controlled input and output combination of the preset changing main controller is illustrated. The preset changing main controller 30 of the present invention includes a change control button 31 and a change selector 32. The change control button servers for controlling the combination about a selected input audio channel, and after setting, the change control button 31 serves to operate a variety of the combinations of the input channel and output channel loops. The change selector 32 serves for changing the combined ways of selection of the main controlling loop selector 13.

The most popular format of a general output loop is 5.1 audio channel. Besides, 7.1 audio channel, even more output ways, can be used, which are used in special cases, for example, stage performance in that all the input channels are assembled to match the required voice emitting points so as to be assembled as a multiple output configuration. In the present invention, the outputs of voices can be arranged based on the viewpoint of visual effect. In that, with the cameras, the positioning of each voice is disposed at a reasonable position, as the viewpoint of image changes, the viewpoint of voice is also changed. The positioning of voice must be designed to match the capturing points of cameras.

For example, in the film studio, the input points of the music instruments of a musical group, such as five input points violin, viola, cello, flute, oboe, are set to the same main controlling loop. The positioning of each input voice is set for the viewpoint face to the studio as a first preset set. The positioning of each input voice is set for the viewpoints to the violin as a second preset set. The positioning of each input voice is set for the viewpoint of the cello and flute as a third and fourth preset sets. Therefore, when the lens of the camera moves to some viewpoint, the preset voices are positioned and combined so that the voices from the viewpoints are completely matched to a frame. Therefore, the defect of the prior art that the voice emitting position is not matched to the positioning the image will not occur.

In the present invention, if only two preset sets are used, it is only necessary to change the first preset set and the second presets so as to match the corresponding image frames. In the present invention, in the case of four preset sets being used to match six viewpoints, one set can be selected as a changeable set, while the other three sets are used to match the most frequent three viewpoints. The changeable set is utilized to match the other three viewpoints. Therefore, the present invention can be set with different combination as required so as to control emitted voices to match the requirement of an image.

Besides, the voice control of the present invention can be designed to match the movement of an object, such as a plane flying over the head, a moving car, etc. In the present invention, the voices of various independent movements can be inputted to the audio channels. Then, unused main controlling loops, for example, second, third, fourth, etc., are selected. Then, each preset sets of these audio channels are set with input start point, passing through point, far away points, . . . If a sound effect process is performed, it is transferred to another one or more audio channels so as to set various preset sets which uses the same main controlling loop so as to achieve the object of synchronization. If high level sound effect processor, a hidden effect, for example Doppler effect, can be set, thereby, the frequency of a sound can be shifted to a higher frequency based the speed of the object. Setting a passing point, then sound is shifted to the lower frequency. Thereby, a three dimensional sound effect is achieved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A control device for mixing and positioning voices, comprising:
an input audio channel controller further comprising:
an input electric balance controller, a plurality of input to output connection controllers; and a main controlling loop selector;
an output audio channel controller; and
a plurality of preset changing main controllers further having: a change control button and a change selector.

2. The control device for mixing and positioning voices as claimed in claim 1, wherein the input electric balance controller is utilized to control parameters of signals from a plurality of input channels.

3. The control device for mixing and positioning voices as claimed in claim 1, wherein the plurality of input to output connection controllers is utilized to set each one of the plurality of input channels to at least one of a plurality of output channels.

4. The control device for mixing and positioning voices as claimed in claim 1, wherein one of the plurality of input to output connection controllers is selected by the main controlling loop selector to be controlled by one of the plurality of preset changing main controllers.

5. The control device for mixing and positioning voices as claimed in claim 1, wherein one of the plurality of input to output connection controllers is set to operate independently without being controlled by the plurality of preset changing main controllers.

6. The control device for mixing and positioning voices as claimed in claim 1, wherein the output audio channel controller controls combination of the plurality of output channels based on combinations of the plurality of input channels to the plurality of output channels set by the plurality of input to output connection controller; and a number of output loops is the same as a number of the combinations set by the plurality of input to output connection controllers.

7. The control device for mixing and positioning voices as claimed in claim 6, wherein the output audio channel controller directly outputs signals based on the combinations set by the plurality of input to output connection controllers, or mixes the signals again and then outputs the mixed signals.

8. The control device for mixing and positioning voices as claimed in claim 1, wherein the change control button servers for switching the combinations set by the plurality of input to output connection controllers, and after one of the combinations being set, the change control button serves to handle a loop of the one of the plurality of input channels to the plurality of output channels by the set combination.

9. The control device for mixing and positioning voices as claimed in claim 1, wherein the change selector serves to change combinations of the main controlling loop selector.

10. A control method for mixing and positioning voices, all input audio channel being assembled into multiple output channels to match required voice emitting points, comprising:
arranging outputs of voices based on a viewpoint of visual effect;
wherein a positioning of each voice is set at a reasonable position based on a viewpoint of a camera, as the viewpoint of a camera is changed, the viewpoint of voice is also changed; positioning of voice must be designed to match capturing points of cameras; and
matching a voice control to movements of objects, wherein unused main controlling loops are selected to be as audio channels of independent movements and each preset sets of the audio channels is set with input start point, passing through point, far away points.

11. The control method for mixing and positioning voices as claimed in claim 10, wherein as visual viewpoint is used to set voice output, a sound effect process is performed, at least one channel is set with various preset sets which are used in the same main controlling loop so that audio and video effects are presented synchronously.

12. The control method for mixing and positioning voices as claimed in claim 10, wherein a sound effect processor is used, a hidden effect of Doppler effect is set, thereby, the frequency of a sound is shifted to a higher frequency based on the speed of an object; and setting a passing point, sound is shifted to the lower frequency; thereby, a three dimensional sound effect is achieved.
